(19) United States
(12) Patent Application Publication
(10) Pub. No.: US 2012/0299481 A1
(43) Pub. Date: Nov. 29, 2012

(54) IN-CIRCUIT TEMPERATURE MEASUREMENT OF LIGHT-EMITTING DIODES

(75) Inventor: Arthur Lionel Stevens, Longmont, CO (US)

(73) Assignee: TerraLUX, Inc., Longmont, CO (US)

(21) Appl. No.: 13/480,810

(22) Filed: May 25, 2012

Related U.S. Application Data
(60) Provisional application No. 61/490,279, filed on May 26, 2011.

(51) Int. Cl. H05B 37/02

(52) U.S. Cl. 315/117

(57) ABSTRACT

Control systems and methods that directly measure the actual junction temperature of LEDs utilize internal electrical measurements, thereby dispensing with external sensors and/or wires. In various embodiments, the actual junction LED temperature is obtained based on the measured electrical properties, such as the voltage across and/or current passing through the LEDs, during operation. The measured junction temperature may be used in a closed-loop feedback configuration to control the power applied to the LED in order to avoid overheating.

### CROSS-REFERENCE TO RELATED APPLICATIONS

This application claims priority to and the benefit of, and incorporates herein by reference in its entirety, U.S. Provisional Patent Application No. 61/490,279, which was filed on May 26, 2011.

### FIELD OF THE INVENTION

Embodiments of the present invention relate, in general, to light-emitting diodes (LEDs), and more specifically to a control system and method for measuring the temperature of LEDs.

### BACKGROUND

An increasing number of light fixtures utilize light emitting diodes (LEDs) as light sources due to their lower energy consumption, smaller size, improved robustness, and longer operational lifetime relative to conventional incandescent light sources. Furthermore, LEDs operate at a relatively low constant temperature in comparison to incandescent light sources. A typical operating temperature of an incandescent filament is over 2000° C., whereas an LED may have a maximum operating temperature of approximately 150° C.; indeed, operation above this temperature can decrease the operational lifetime of the LED. At high temperatures the carrier recombination processes and a decrease in the effective optical band gap of the LED decrease the light output of the LED. Therefore, a typical operating temperature of a LED is controlled below 100° C. in order to preserve operational lifetime while maintaining acceptable light output.

In addition, high-power LEDs used for room lighting require more precise current and heat management than compact fluorescent lamp sources of comparable output. LEDs that use from 500 milliwatts to as much as 10 watts in a single package have become standard, and even higher-power LEDs are expected to be used in the future. Some of the electricity in any LED becomes heat rather than light, and particularly in the case of high-power LEDs, it is essential to remove enough of that heat to prevent the LED from running at high temperatures. Thus, thermal monitoring of LEDs is desirable and, in high-power applications, critical.

Conventionally, LED lighting systems use sensors, e.g., thermocouples or thermistors to measure and monitor temperatures of LEDs. These sensors are located near the LED and connected to a temperature-monitoring system, typically using a separate dedicated set of wires. These temperature-detection sensors generally cannot directly measure the actual junction temperature of the LED itself, since they are spaced apart from the LED due to optical and connectivity considerations. This can result in measurement inaccuracies. Inaccurate measurements of the LED temperature may cause poor performance and reduce the lifetime of the LED. Additionally, an extra set of wires between the thermistor and the monitoring system can be inconvenient, especially if the monitoring system is far from the thermistor. Finally, the extra cost of the sensors and wires, and their placement within the circuit, represent another disadvantage of utilizing external sensors.

Consequently, there is a need for an approach to directly measure the LED temperature and adjust the temperature accordingly for optimizing the performance and lifetime of the LED.

### SUMMARY

In various embodiments, the present invention relates to control systems and methods that directly measure the actual junction temperature of LEDs utilizing internal electrical measurements, thereby dispensing with external sensors and/or wires. The actual junction LED temperature is obtained based on the measured electrical properties, such as the voltage across and/or current passing through the LEDs, during operation. The measured junction temperature may be used in a closed-loop feedback configuration to control the power applied to the LED in order to avoid overheating. This approach provides a fast, easily implemented, and inexpensive way to directly and accurately measure and control the junction temperature of LEDs in a lighting system, thereby optimizing the performance and lifetime of the LEDs.

Accordingly, in one aspect, the invention pertains to a system including an LED, a constant-current source switchably connectable to the LED, and a controller for determining the junction temperature of the LED based at least in part on a temperature coefficient and a measured voltage across the LED with the constant-current source connected thereto. In various embodiments, the system includes a power supply and an LED power controller for controlling, based on the temperature coefficient, a load current supplied by the power supply to the LED to maintain a temperature of the LED during operation within a fixed range. The system may further include a switch for switching a power source of the LED between the power supply and the constant-current source; the LED power controller is then switchably connectable to the LED so as to disconnect the power supply from the LED when the constant-current source is connected thereto.

In some embodiments, the controller computes the temperature coefficient based at least in part on multiple temperatures at which the LED is operated and multiple voltages, each associated with one of the multiple temperatures, measured across the LED. A memory may be included in the system for storing the temperature coefficient and/or the multiple temperatures at which the LED is operated and the multiple voltages, each associated with one of the multiple temperatures, measured across the LED. The temperature coefficient may satisfy the equation:

$${C}_{T} = \frac{{V}_{f 2 } - {V}_{f 1}}{{T}_{2} - {T}_{1}} ,$$

where C_{T} denotes the temperature coefficient, V_{f1} and V_{f2} are two of the plurality of voltages measured across the LED, and T₁ and T₂ are two of the plurality of temperatures at which the LED is operated.

The system may include a detecting sensor for detecting a luminous intensity of LED light in an environment; the LED power controller may be responsive to the sensor to control the load current based on the temperature coefficient and the detected luminous intensity.

In a second aspect, the invention relates to a method of operating an LED within a fixed temperature range. In various embodiments, the method includes: (i) measuring an actual junction temperature of the LED in real time; (ii) based on the measured real-time junction temperature and a load current of the LED, determining an operational current corresponding to a target operating temperature; and (iii) adjusting the load current to the determined operational current to maintain the LED at the target temperature. The method may include repeating steps (i), (ii), and (iii). In one embodiment, the method further includes detecting a luminous intensity of LED light in an environment and adjusting the load current to maintain a value of LED brightness.

In some embodiments, measuring an actual junction temperature of the LED includes establishing a temperature coefficient of the LED; operating the LED at a constant current and measuring the voltage thereacross; and based on the measured voltage and the temperature coefficient, determining the actual junction temperature of the LED. In one implementation, determining the actual junction temperature includes calculating the temperature coefficient of the LED. Further, calculating the temperature coefficient may include operating the LED at a constant current at multiple temperatures and measuring a voltage thereacross at each of the temperatures. The temperature coefficient may then be calculated by establishing a relationship between the multiple temperatures at which the LED is operated and multiple voltages, each associated with one of the multiple temperatures, measured across the LED. For example, the temperature coefficient may satisfy an equation:

$${C}_{T} = \frac{{V}_{f 2 } - {V}_{f 1}}{{T}_{2} - {T}_{1}} ,$$

where C_{T} denotes the temperature coefficient, V_{f1} and V_{f2} are two of the plurality of voltages measured across the LED, and T₁ and T₂ are two of the plurality of temperatures at which the LED is operated.

As used herein, the term “approximately” means ±10%, and in some embodiments, ±5%. Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the invention. In the following description, various embodiments of the present invention are described with reference to the following drawings, in which:

FIG. 1A depicts a depletion region in a semiconductor diode and the charge density, electric field, and built-in potential across the depletion region;

FIG. 1B is a current-voltage (I-V) curve of semiconductor diodes;

FIG. 2 illustrates an equivalent circuit diagram of an LED;

FIGS. 3A and 3B depict characteristic curves of an LED operating at temperatures from 0° C. to 80° C. on a linear plot and a semi-logarithmic plot, respectively;

FIG. 4 depicts characteristic I-V curves of six LEDs connected in series at temperatures from 0° C. to 80° C. on a semi-logarithmic plot;

FIG. 5 depicts temperature coefficients of six LEDs connected in series at operating currents of 1 mA and 100 μA;

FIG. 6 is an implementation of an LED thermometry system in accordance with an embodiment of the invention; and

FIG. 7 is a method for directly measuring the temperature of LEDs in accordance with an embodiment of the invention.

### DETAILED DESCRIPTION

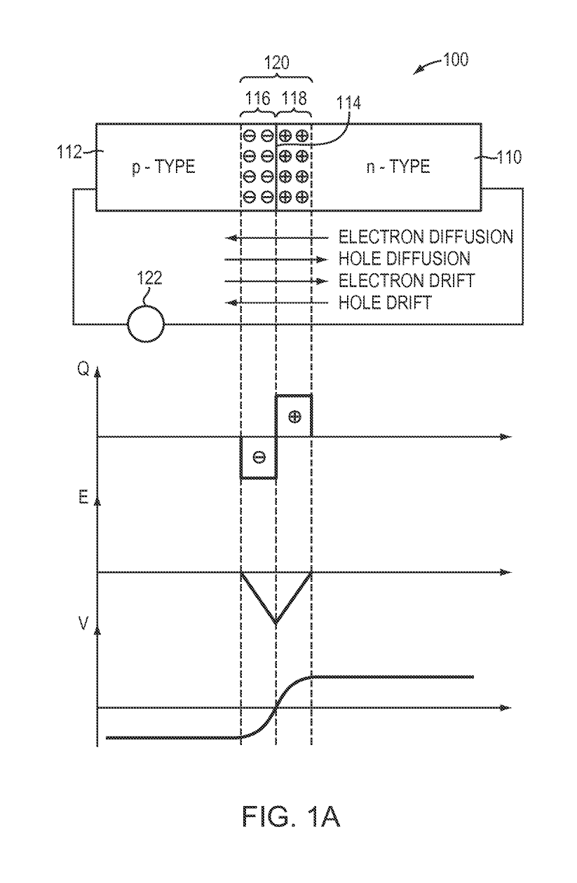

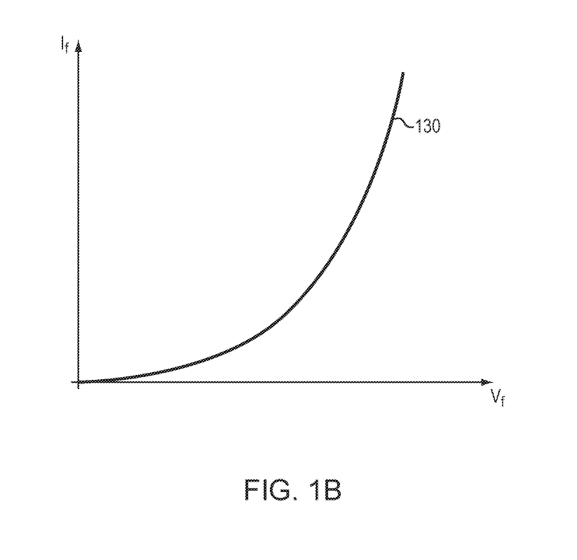

Refer first to FIG. 1A, which schematically illustrates a modern semiconductor diode 100 composed of a crystalline material, e.g., silicon, that has added impurities to create an n-type semiconductor 110 (which contains negative charge carriers, i.e., electrons) or a p-type semiconductor 112 (which contains positive charge carriers, i.e., holes). After joining the n-type and p-type semiconductors 110, 112 together, electrons near the resulting p-n junction 114 tend to diffuse into the p-type region 116; likewise, holes near the p-n junction 114 diffuse into the n-type region 118. Following such movement, the diffused electrons and holes in p-type region 116 and n-type region 118, respectively, are eliminated due to recombination with the complementary charge carriers; this creates a depletion region 120 in which charge carriers are not mobile. The uncompensated positive and negative charge carriers left on the n-type side and p-type side, respectively, create an electric field E and a “built-in” potential V across the depletion zone 120; the created electric field E causes electrons to drift from the p-type side to the n-type side and holes to drift in the opposite direction. FIG. 1A illustrates the charge density, Q, the electric field E the built-in potential V diffused electrons and holes, and charge drift across the depletion region 120. The depletion region 120 reaches equilibrium at a given temperature when the electric field E prevents further drift and diffusion of electrons and holes.

Upon applying an external voltage 122 whose polarity opposes the “built-in” potential (i.e., a forward voltage), the crystal conducts electrons from the n-type side 110 to the p-type side 112 across the p-n junction 114 and thereby generates a substantial electric current (i.e., a forward current) through the p-n junction 114. Referring to FIG. 1B, a measured current-voltage (I-V) curve 130 can be used to characterize the behavior of semiconductor diodes in a circuit. For example, the shape of the curve is determined by the transport of charge carriers through the depletion region 120 near the p-n junction 114. Typically, an approximate forward voltage (V_{f}) versus forward current (I_{f}) model of an LED operating at temperatures between 0° C. and 80° C. may be given by the equation:

$${V}_{f} = {nV}_{T} ln [ \frac{{I}_{f}}{{I}_{s}} ] + {R}_{s} {I}_{f} \qquad ( 1 )$$

where n is the diode ideality factor which has a value between 1 and 2, Rₛ is the series resistance, Iₛ is the reverse saturation current, and V_{T} is the thermal voltage. The thermal voltage V_{T} depends on the absolute operating temperature T, and is given as:

$${V}_{T} = \frac{kT}{q} \approx \frac{{T}_{C} + 273.15}{11604.51} \qquad ( 2 )$$

where q is the magnitude of the electrical charge on the electron, k is Boltzmann's constant, and T_{C} is temperature in ° C. Based on equations (1) and (2), the thermal voltage is computed; a typical value is approximately 26 mV at a room temperature of 300 K (27° C.).

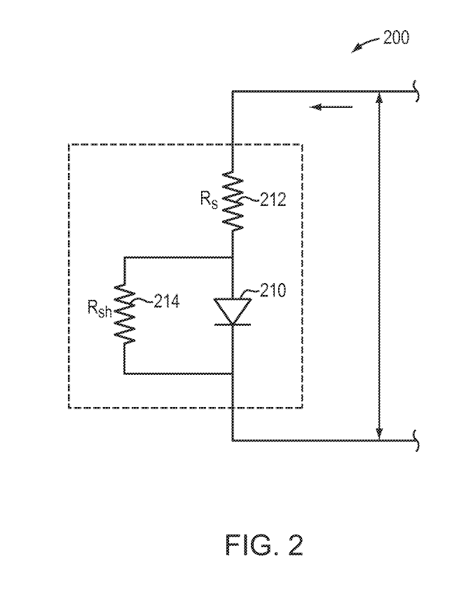

Referring to FIG. 2, the actual diode voltage upon applying an external voltage can be deduced from the total operating voltage based on the equivalent circuit diagram 200 of an LED; the diagram 200 includes a diode junction 210, a series resistance Rₛ, and a shunt resistance, Rₛₕ. The operating voltage, V_{f}, at a measured current, I, is divided across the two circuit elements: Rₛ, and the diode 210 as:

V_{f}=IR_{S}+V_{d} (3)

where Rₛ is the series resistance and V_{d} is the voltage across the diode. At relatively low voltages, typically below 1.5 V to 2 V, the shunt resistance Rₛₕ of the equivalent circuit 200 dominates and the LED remains cool and produces little useful light. At relatively high voltage, typically above 2.5 V, the series resistance Rₛ dominates and the high voltage is near the limit of LED operation. Thus, a typical operating voltage is above where the shunt resistance Rₛₕ dominates and below where the series resistance Rₛ dominates. To determine the series resistance Rₛ the LED should be operated so that the series resistance dominates. The voltage across the series resistance Rₛ at high current is much larger than the voltage drop V_{d} across the diode 210. An approximate value for Rₛ can then be obtained from the exponential curve, shown in FIG. 1B, by graphically determining the final slope of the curve at a high current (i.e., by calculating the ratio of voltage to current). For example, for LEDs that have characteristic curves as illustrated in FIG. 1B, the series resistance is given by Rₛ≈0.41Ω.

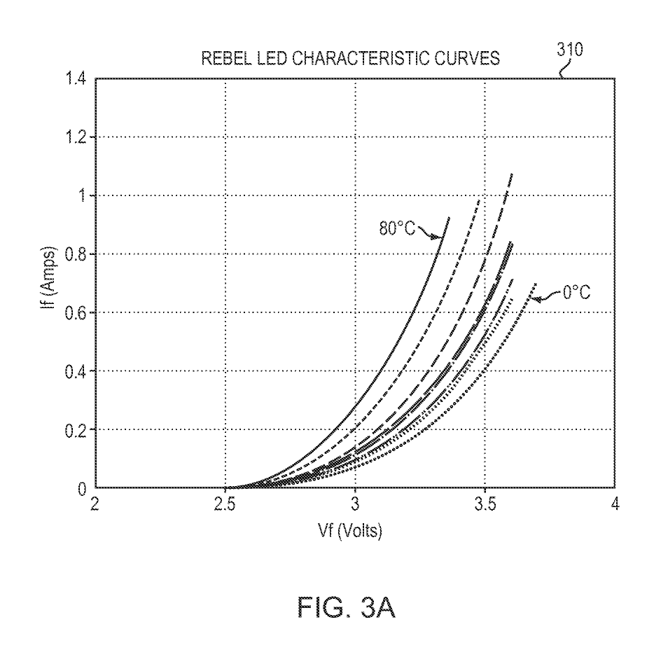

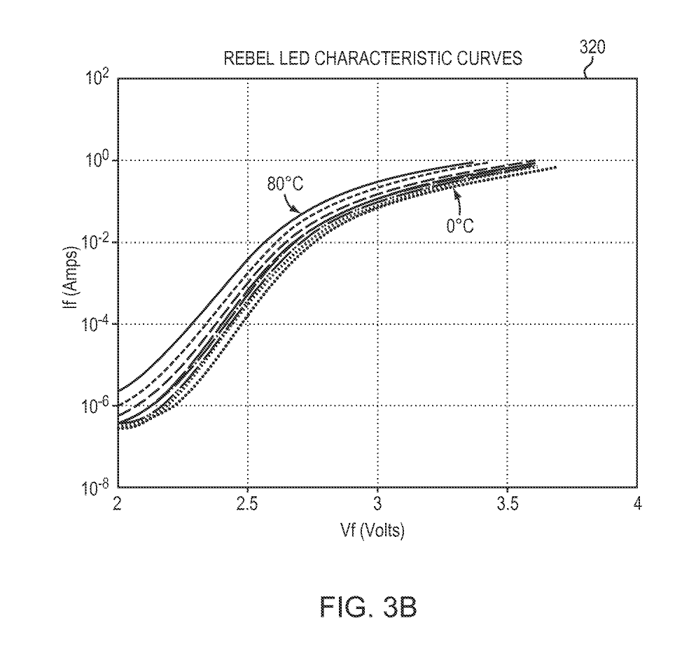

With reference to FIG. 3A, because the characteristic I-V curve of, for example, a REBEL LED is highly temperature-dependent, the temperature of the LED can be properly determined by manipulating and measuring its voltage and current if the values of the other parameters in Equation (1) are available. The characteristic I-V curve in a linear plot 310, however, has an exponential shape; this indicates that a small increase in the forward voltage V_{f} results in a much larger increase in the forward current I_{f}. In other words, the current I_{f} covers a large range of values while the voltage V_{f} has only a restricted range of values. A semi-logarithmic plot 320, as depicted in FIG. 3B, may be utilized to improve the resolution of the current I_{f} in the diagram and thus bring out features in the data that would not easily be seen when both V_{f} and I_{f} are plotted linearly. The characteristic features of V_{f} and I_{f}, especially in the range of small voltages or currents (e.g., V_{f}<3 V or I_{f}<0.1 A) are clarified in the semi-logarithmic plot 320 compared with those presented in a linear plot 310. Note that the operating current starts to bend to the right at a forward voltage V_{f} of about 3.2V in the top region because as current rises, resistance begins to dominate the exponential characteristics of the diode string.

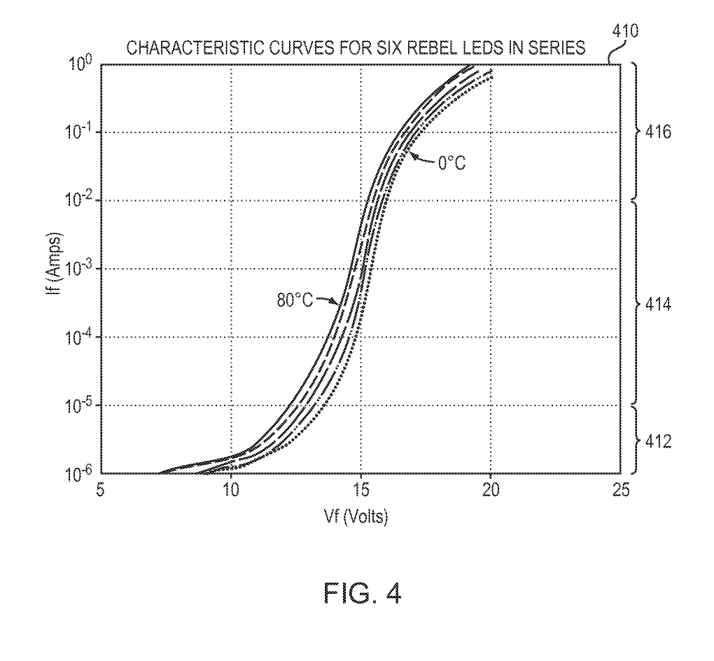

Multiple LEDs connected in series will require a larger voltage to operate at the same current as a single LED. FIG. 4 depicts a semi-logarithmic plot 410 of the I_{f}-V_{f} characteristic curves of six series-connected LEDs at temperatures between 0° C. and 80° C. with 20° C. increments. The individual curves are equally spaced since their temperature values are 20° C. apart. Experimentally, with renewed reference to FIG. 3B, the forward voltage V_{f} of a single LED varies from 2.474 V at 0° C. to 2.289 V at 80° C. at an operating current of 100 μA. This means there is a 185 mV change in the forward voltage over an 80° C. temperature range. This change, in turn, corresponds to a temperature coefficient C_{T} (where

$${C}_{T} = \frac{Δ {V}_{f}}{Δ T} )$$

of approximately −2.3 mV/° C. for a single LED. As shown in FIG. 4, with the same forward current of 100 μA, the total forward voltage Vₐ varies between 14.82 V at 0° C. and 13.734 V at 80° C., i.e., a change of 1.086 V over an 80° C. temperature range. This corresponds to a temperature coefficient of approximately −13.575 mV/° C. for six series-connected LEDs; thus, the temperature coefficient of six series-connected LEDs is approximately six times that of the single LED operating at the same current.

In addition, the curves in FIG. 4 are steeper than those in FIG. 3B because the effective series resistance Rₛ, of six series-connected LEDs is larger than that of one LED. In theory, if m LEDs are connected in series, the total applied voltage Vₐ is m times the forward voltage V_{f} of each LED because the forward current I_{f} flowing through them is the same. By regarding the series string of LEDs as a single LED device, the total applied voltage is given by:

$${V}_{a} = {\sum }_{i = 1}^{m} {V}_{fi} = {nV}_{T} [ {ln ( {I}_{f} )}^{m} - ln ( {\prod }_{i = 1}^{m} {I}_{si} ) ] + {I}_{f} {\sum }_{i = 1}^{m} {R}_{si} . \qquad ( 4 )$$

Assuming that the characteristic curve of a series string of LEDs is similar to that of a single LED, the composite string may be modeled using the equation:

$$V = {nV}_{T} ln [ \frac{{\tilde{I}}_{f}}{{\tilde{I}}_{s}} ] + {\tilde{I}}_{f} {R}_{st} \qquad ( 5 )$$

which is of the same form as Equation (1), with

$${\tilde{I}}_{f} = {( {I}_{f} )}^{m} , {\tilde{I}}_{s} = {\prod }_{i = 1}^{m} {I}_{si} , and {R}_{st} = {\sum }_{i = 1}^{m} {R}_{si} .$$

For m identical LEDs:

Vₐ=m[nV_{T} ln(I_{f}/m)+E_{g}+I_{f}Rₛ] (6)

where E_{g} is a value of the effective optical band gap. Equation (6) thus indicates that the total applied voltage Vₐ of m identical LEDs in series is equal to m times the forward voltage V_{f} of an individual LED when the LEDs are operated at the same forward current I_{f}.

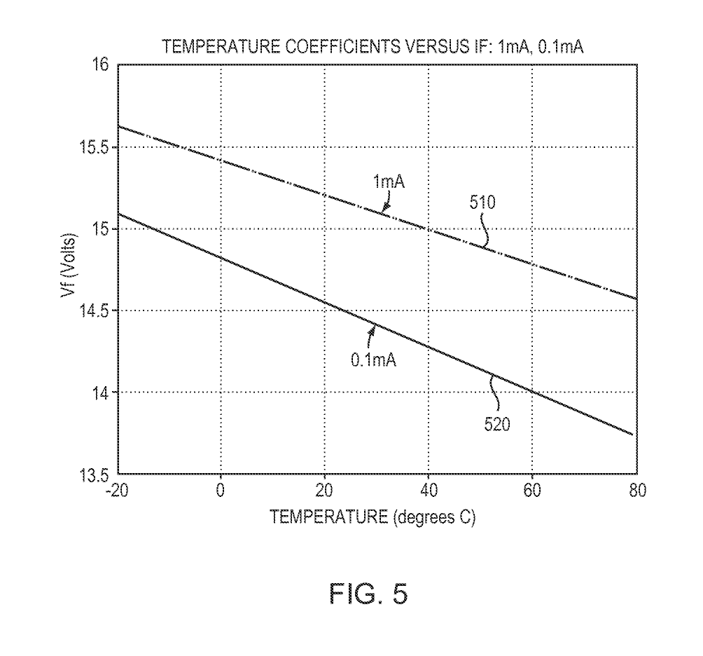

Equation (6) also indicates that, theoretically, a relatively bigger drop of the forward voltage due to temperature increase—i.e., a larger temperature coefficient—should occur at a smaller LED operating current. FIG. 5 depicts the relationship between the forward voltage V_{f} and temperature T for two values of constant forward current, i.e., I_{f}=1 mA (line 510) and I_{f}=100 μA (line 520). If these two lines 510, 520 are extended to the left, they will eventually meet at a temperature of absolute zero. Experimentally, the temperature coefficients are given by the slopes of the lines 510, 520, showing that the coefficient is larger for smaller values of the operating current (i.e., 100 μA) as expected in theory. This effect can also be observed from the curves in FIGS. 3B and 4, where it is evident that the horizontal voltage difference between adjacent curves decreases as the vertical operating current increases. Thus, both theoretically and experimentally, for multiple LEDs (e.g., m LEDs) connected in series, a temperature coefficient approximately m times as large as that for a single LED operating at the same forward current is to be expected. Accordingly, in some embodiments, m series-connected LEDs provide a larger corresponding voltage increase in temperature resolution.

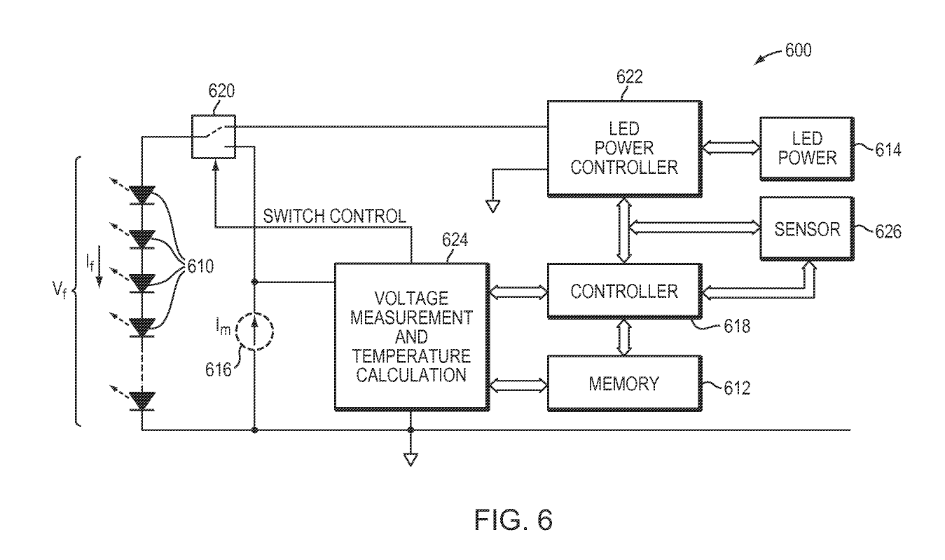

Referring to FIG. 6, in various embodiments, a thermometer 600 is utilized to directly measure the junction temperature of LEDs 610 utilizing the temperature coefficient. A fixed DC forward current I_{f} is passed through the LEDs 610, and the corresponding forward voltage V_{f} across the LEDs 610 is measured. Because the temperature coefficient of a semiconductor device, such as an LED, is constant when the device is operated at a constant forward current, the junction temperature of the LEDs 610 can be calculated if the temperature coefficient of the LEDs 610 at this operating current is known: the junction temperature T is proportional to the forward voltage V_{f} at the fixed forward current I_{f}. The temperature coefficient is larger for a smaller operating current, and therefore, it is advantageous to choose a smaller operating current so that a larger voltage difference is produced for a given temperature change. This facilitates accurate measurement of the voltage V_{f}.

In one embodiment of the invention, the value of the temperature coefficient of the LED(s) 610 is determined using an offline calibration procedure. The value of the temperature coefficient and the calibration temperature are then stored, for example, in an area of non-volatile memory 612 in a monitoring and control module. Referring back to FIG. 4, the S-shaped I-V characteristic curves on the semi-logarithmic plot 410 can be split into three distinct regions 412, 414, 416: (i) the “dark” low current region 412 located at the bottom of the “S” shape of the curve (below approximately 10⁻⁵ A), (ii) the middle “linear” constant-slope region 414 where the LEDs begin to emit low-intensity light (between approximately 10⁻⁵ A and 10⁻² A), and (iii) the operating current region 416 located at the top of the set of curves where it bends to the right (above approximately 10⁻² A). Since the temperature coefficient is larger at smaller current values and a reasonably large current has to flow through LEDs to cause light emission, a proper choice for the calibration current thus would be around 10⁻⁴ A=100 μA. Additionally, the choice of this small current can reduce internal heating of the LEDs.

Referring again to FIG. 6, in various embodiments, to determine the junction temperature of the LED(s) 610 at any given time, the power 614 to the LED(s) 610 is temporarily disconnected and a constant current 616 is applied to the LED(s) 610 for a short time duration t; the time duration t is sufficient for measuring the voltage across the LEDs 610 but insufficient to be detected by the human eye, thereby imposing at most a negligible impact on normal LED operation. The applied current 616 is not critical and reflects an engineering tradeoff: typically, the current will lie in the linear region 414 of the S-shaped characteristic curve of the LED being monitored, as described above, and should produce a large enough voltage signal to be measured with adequately low error—that is, if the chosen current 616 is too small, then the voltage across the LEDs 610 at that current will also be small and the measurement resolution will be reduced. If the chosen current 616 is too large, on the other hand, internal heating will cause errors (even though the voltage signal will be large and thereby aid resolution). The optimal current, therefore, reflects the characteristic curve for a particular manufacturer's LED (i.e., the voltage range produced over the temperature range being measured), as well as the complexity of the voltage measurement circuitry being employed.

In various embodiments, while the constant current 616 is flowing through the LED(s) 610, the voltage across the LED(s) 610 is measured and the junction temperature is calculated by the controller 618 (e.g., by firmware in the controller's microprocessor). The controller 618 schedules a time for a temperature measurement to take place and, at the appointed time, the electronically controlled switch 620 is flipped to connect the constant current source 616 to the LED(s) 610. While the switch 620 is in this position, the power controller module 622 is temporarily disabled and the voltage measurement 624 of the LED(s) 610 is taken. Once the measurement is complete, the switch 620 is restored to its original position and the LED power control resumes. The measured voltage is then processed by the controller 618 to calculate the junction temperature and, based thereon, an operational current and temperature that optimizes the performance and lifetime of the LED can be calculated by the controller 618. Values for the optimal load current and the associated temperature are sent to the LED power controller 622 and appropriate actions can be taken—e.g., adjustment of the load current and the associated temperature to optimize the lifetime of the LED or shutdown the circuit due to overheating or any other fault conditions. In one embodiment, the thermometer 600 includes a detecting sensor 626; upon detecting a luminous intensity of light in the environment below a predetermined threshold, the sensor transmits a signal to the controller 618, automatically triggering a larger load current to flow through the LEDs 610, thus increasing the brightness of the LEDs 610. The temperature increase resulting from the current increase is measured and monitored by the controller 618; the controller 618 adjusts the load current again to prevent overheating of the LEDs 610. This process may be repeated until an optimal combination (e.g., in terms of performance and LED lifetime) of LED brightness and operating temperature is achieved. Systems and methods based on this approach provide a fast, easily implemented, and inexpensive way to directly measure the actual junction temperature of the LEDs and optimize the performance and lifetime of the LEDs. A temperature coefficient can be determined by simply measuring the LED voltage at various temperatures while the LED is driven at a constant current. The resulting straight line provides the temperature coefficient per Equation (7) below. In general, a single coefficient is determined from the slope of the line. If multiple lines are obtained due to errors in the measurements, a curve fit, such as a regression analysis, may be employed and the average slope obtained. However, this is rarely necessary as the physical behavior of the LEDs is well controlled by the manufacturer and by the physics of semiconductors.

The controller 618 and/or the LED power controller 622 may be provided as either software, hardware, or some combination thereof. For example, the system may be implemented on one or more server-class computers, such as a PC having a CPU board containing one or more processors such as the CORE PENTIUM or CELERON family of processors manufactured by Intel Corporation of Santa Clara, Calif. and POWER PC family of processors manufactured by Motorola Corporation of Schaumburg, Ill., and/or the ATHLON line of processors manufactured by Advanced Micro Devices, Inc., of Sunnyvale, Calif. The controller 618 and/or the LED power controller 622 may also include a main memory unit for storing programs and/or data relating to the methods described above. The memory may include random access memory (RAM), read only memory (ROM), and/or FLASH memory residing on commonly available hardware such as one or more application specific integrated circuits (ASIC), field programmable gate arrays (FPGA), electrically erasable programmable read-only memories (EEPROM), programmable read-only memories (PROM), or programmable logic devices (PLD). In some embodiments, the programs are provided using external RAM and/or ROM such as optical disks, magnetic disks, as well as other commonly used storage devices.

For embodiments in which the controller 618 and/or the LED power controller 622 are provided as a software program, the program may be written in any one of a number of high level languages such as FORTRAN, PASCAL, JAVA, C, C++, C#, LISP, PERL, BASIC, PYTHON or any suitable programming language. Additionally, the software can be implemented in an assembly language and/or machine language directed to the microprocessor resident on a target device.

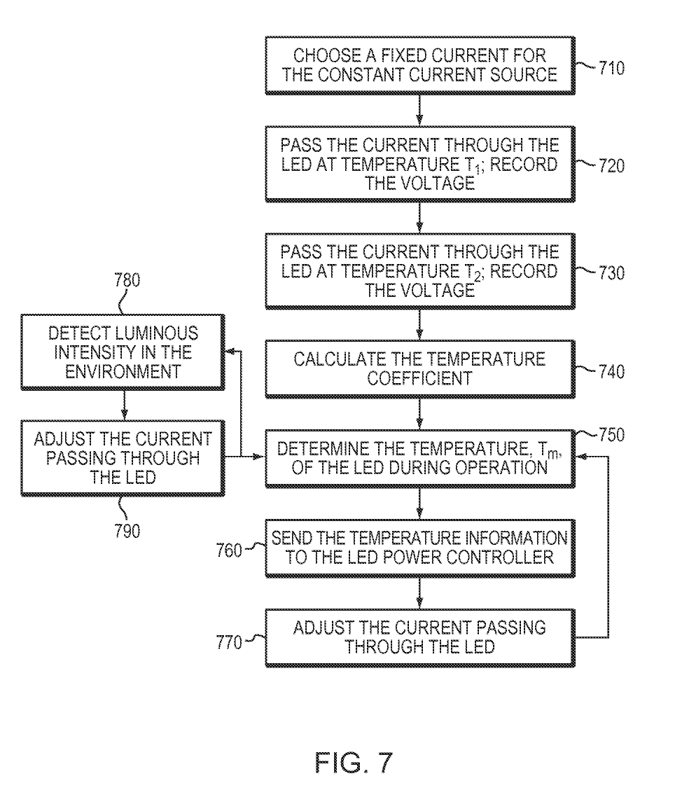

In some embodiments, a constant current is passed through the LEDs and the voltage across them is measured at a plurality of temperatures (at least two: the maximum and minimum expected operating temperatures). Then a straight line is drawn between the temperature-voltage pairs and the coefficient is determined as the slope of the line of the resulting graph in volts per ° C. (or mV/° C.). Referring to FIG. 7, in some embodiments, the following steps are used to calibrate the thermometer, measure an actual junction temperature of the LED(s) during operation, and adjust the temperature accordingly:

(A) choosing a fixed operating current, such as 100 μA as previously discussed, for the constant current source (step 710);

(B) passing the fixed current through the LED(s) at a temperature, T₁, and recording the value of the forward voltage, V_{f1}, across the LED(s) (step 720);

(C) passing the fixed current through the LED(s) at a temperature T₂ and recording the value of the forward voltage V_{f2} (step 730). A reasonably large range of temperatures between T₁ and T₂ should be used as is feasible;

(D) calculating the temperature coefficient (step 740) using the following formula:

$${C}_{T} = \frac{{V}_{f 2 } - {V}_{f 1}}{{T}_{2} - {T}_{1}} mV \text{/} ° C . \qquad ( 7 )$$

(E) determining the temperature, Tₘ, of the LED(s) operated under a normal condition (step 750) as:

$${T}_{m} = {T}_{2} + \frac{{V}_{m} - {V}_{f 2}}{{C}_{T}} ° C . \qquad ( 8 )$$

where Vₘ is the measured forward voltage across the m LED(s) at the same fixed current that was used for the calibration. As an example, assume that T₂=85° C., V_{f2}=15.50 V, C_{T}=−14 mV/° C., and the voltage measured across the LED(s) is Vₘ=15.22 V, we can calculate the temperature of the LED(s) as:

$${T}_{m} = 85 + \frac{15.22 - 15.50}{- 14 \times {10}^{- 3}} = 105 ° C .$$

(F) sending the information about the computed temperature to the LED power controller (step 760); and

(G) adjusting the load current passing through the LEDs to change the LED temperature (step 770).

In one embodiment, steps 750-770 are iteratively implemented until the measured temperature of the LED(s) is optimized for LED performance and lifetime; the temperature is then maintained within a fixed range (e.g., within ±10% of the recommended operating temperature) during LED operation. This approach thus provides a fast and inexpensive way to directly measure the actual junction temperature of LEDs and adjust the temperature accordingly.

In some embodiments, the luminous intensity in the environment is detected (step 780). If the intensity is below a threshold, a larger load current is adjusted to flow through the LEDs to increase the brightness (step 790). The temperature increase resulting from the current increase is then measured and this temperature information is sent to the controller to further adjust the load current to prevent overheating of the LEDs, if necessary. This process may be repeated until an optimal combination (e.g., in terms of performance and LED lifetime) of LED brightness and operating temperature is achieved.

In accordance with the approach disclosed herein, LED manufacturers may publish a table of temperature coefficients versus current. The lighting designer may then choose a measurement current based on the considerations outline above, and obtain the corresponding coefficient. The coefficient may be multiplied by the number of LEDs in the circuit to derive the overall coefficient for that current. The selected number of LEDs may then be connected in series and voltage measured at even a single selected temperature. This information (the coefficient and the one temperature-voltage point, as well as the measurement current value chosen) may be stored in memory, and firmware in the lighting module or luminaire can then determine the temperature of the LEDs during operation. The same data obtained from the single measurement could be stored in all lighting devices that use the same type and number of LEDs.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A system comprising:
a light emitting diode (LED);
a constant-current source switchably connectable to the LED; and
a controller for determining the junction temperature of the LED based at least in part on a temperature coefficient and a measured voltage across the LED with the constant-current source connected thereto.

2. The system of claim 1, further comprising a power supply and an LED power controller for controlling, based on the temperature coefficient, a load current supplied by the power supply to the LED to maintain a temperature of the LED during operation within a fixed range.

3. The system of claim 2, wherein the LED power controller is switchably connectable to the LED so as to disconnect the power supply from the LED when the constant-current source is connected thereto.

4. The system of claim 2, further comprising a detecting sensor for detecting a luminous intensity of LED light in an environment, wherein the LED power controller is responsive to the sensor to control the load current based on the temperature coefficient and the detected luminous intensity.

5. The system of claim 1, further comprising a switch for switching a power source of the LED between the power supply and the constant-current source.

6. The system of claim 1, wherein the controller computes the temperature coefficient based at least in part on a plurality of temperatures at which the LED is operated and a plurality of voltages, each associated with one of the plurality of temperatures, measured across the LED.

7. The system of claim 6, wherein the temperature coefficient satisfies the equation:
$${C}_{T} = \frac{{V}_{f 2 } - {V}_{f 1}}{{T}_{2} - {T}_{1}} ,$$
where C_{T} denotes the temperature coefficient, V_{f1} and V_{f2} are two of the plurality of voltages measured across the LED, and T₁ and T₂ are two of the plurality of temperatures at which the LED is operated.

8. The system of claim 1, further comprising a memory for storing at least one of a temperature coefficient of the LED or a plurality of temperatures at which the LED is operated and a plurality of voltages, each associated with one of the plurality of temperatures, measured across the LED.

9. A method of operating a light emitting diode (LED) within a fixed temperature range, the method comprising:
(i) measuring an actual junction temperature of the LED in real time;
(ii) based on the measured real-time junction temperature and a load current of the LED, determining an operational current corresponding to a target operating temperature; and
(iii) adjusting the load current to the determined operational current to maintain the LED at the target temperature.

10. The method of claim 9, wherein measuring an actual junction temperature of the LED comprises:
establishing a temperature coefficient of the LED;
operating the LED at a constant current and measuring the voltage thereacross; and
based on the measured voltage and the temperature coefficient, determining the actual junction temperature of the LED.

11. The method of claim 10, wherein determining the actual junction temperature comprises calculating a temperature coefficient of the LED.

12. The method of claim 11, wherein calculating the temperature coefficient of the LED comprises operating the LED at a constant current at a plurality of temperatures and measuring a voltage thereacross at each of the temperatures.

13. The method of claim 10, wherein the temperature coefficient is calculated by establishing a relationship between a plurality of temperatures at which the LED is operated and a plurality of voltages, each associated with one of the plurality of temperatures, measured across the LED.

14. The method of claim 13, wherein the temperature coefficient satisfies an equation:
$${C}_{T} = \frac{{V}_{f 2 } - {V}_{f 1}}{{T}_{2} - {T}_{1}} ,$$
where C_{T} denotes the temperature coefficient, V_{f1} and V_{f2} are two of the plurality of voltages measured across the LED, and T₁ and T₂ are two of the plurality of temperatures at which the LED is operated.

15. The method of claim 9, further comprising repeating steps (i), (ii), and (iii).

16. The method of claim 9, further comprising detecting a luminous intensity of LED light in an environment and adjusting the load current to maintain a value of LED brightness.
